(19) United States
(12) Patent Application Publication
(10) Pub. No.: US 2025/0229999 A1
(43) Pub. Date: Jul. 17, 2025

(54) SYSTEMS AND METHODS FOR REDIRECTING AIRFLOW IN TRANSPORT SYSTEMS

(71) Applicant: Trans-Vac Systems LLC, Denver, CO (US)

(72) Inventor: Michael Boyd, Denver, CO (US)

(21) Appl. No.: 19/018,766

(22) Filed: Jan. 13, 2025

Related U.S. Application Data
(60) Provisional application No. 63/620,712, filed on Jan. 12, 2024.

(51) Int. Cl. B65G 51/10; B65G 51/28

(52) U.S. Cl. CPC B65G 51/10; B65G 51/28

(57) ABSTRACT

Systems and methods for managing airflow across a transport system are provided. The transport system includes a main transport pipe connected to a collection area configured to collect objects and materials transported through the transport system. The systems and methods also include a branch transport pipe connected to the main transport pipe and a loading station and a loop riser pipe connecting between the main transport pipe and the branch transport pipe. The systems and methods also include a redirector configured to regulate airflow to at least one of the loop riser pipe or the main transport pipe.

### CROSS REFERENCE TO RELATED APPLICATIONS

This U.S. Non-Provisional Patent application claims priority from U.S. Provisional Patent Application Ser. No. 63/620,712, filed Jan. 12, 2024, the entire disclosure of which is hereby expressly incorporated by reference.

### FIELD

The present disclosure relates generally to collection and transport systems. These systems include, but are not limited to, vacuum waste or linen collection systems. More specifically, certain embodiments of the present disclosure provide collection and transport systems with one or more loop riser pipes wherein airflow can be redirected from a main pipe to a loop riser pipe at a collection point.

### BACKGROUND

Collection and transport systems using a combination of interconnecting pipes, conduits and tubing are useful for safely and efficiently transporting materials. Such systems are known to be used for transporting materials such as waste, linens, currency, and other objects from point to point. The systems can also convey materials between different locations in a building, a development, or other interconnected space to a collection area or point.

In various systems including, but not limited to collection and transport systems, entry points or “loading stations” are provided as a means of ingress for materials into the system. In some embodiments, the system may be a vacuum collection system having loading stations that are connected to and feed material to a storage chamber or chute. The storage chamber or chute receives, and occasionally stores materials prior to delivery of the materials into a transport pipe. Collection systems and chutes are commonly used in commercial buildings like hospitals, apartments, etc. to transport waste, recycling and/or dirty linens.

The systems use a series of conduits such as tubing or pipes (herein referred to as pipes or piping) to connect the loading stations to a collection point and to connect the loading stations to a pneumatic source. The pipes used to connect the loading stations to a pneumatic source may connect each loading station to the pneumatic source or to a main conduit of the pneumatic source separately, resulting in the use of lengthy sections of piping for loading stations located further away from the pneumatic source. Further, the pneumatic source(s) may be difficult to locate or find at intermediate system branches due to the use of lengthy sections of piping.

### SUMMARY

Accordingly, there has been a long-felt but unmet need to reduce piping in collection and transport systems.

A transport system according to at least one embodiment of the present disclosure comprises a main transport pipe connected to a collection area; a branch transport pipe connected to the main transport pipe and a loading station; a loop riser pipe connecting the main transport pipe and the loading station; and a redirector configured to regulate airflow to direct the airflow to at least one of the loop riser pipe or the main transport pipe, wherein when the airflow is directed to the loop riser pipe, the airflow is provided to the loading station to aid in moving objects deposited in the loading station to the main transport pipe via the branch transport pipe.

Any of the aspects herein, wherein the redirector comprises at least one of a diverter or a pair of dampers.

Any of the aspects herein, wherein the redirector comprises the pair of dampers, and wherein a first damper is positioned upstream of the loading station and the second damper is positioned on the main transport pipe.

Any of the aspects herein, wherein the redirector comprises the diverter, and wherein the diverter is positioned at a junction of the main transport pipe and the loop riser pipe.

Any of the aspects herein, wherein the redirector is automatically controlled by a control system.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In addition, the materials, methods, and examples are illustrative only and are not intended to be necessarily limiting.

### DESCRIPTION OF THE DRAWINGS

FIG. 1A is a perspective view of components of a transport system according to according to one embodiment of the present disclosure;

FIG. 1B is a diagram of a transport system according to one embodiment of the present disclosure;

FIG. 2A is a perspective view of a set of components of a transport system according to according to one embodiment of the present disclosure;

FIG. 2B is a diagram of a transport system according to one embodiment of the present disclosure;

FIG. 3 is a perspective view of a transport system according to one embodiment of the present disclosure;

FIG. 4A is a diagram of a redirector of a loop riser pipe in a closed configuration according to one embodiment of the present disclosure;

FIG. 4B is a diagram of a redirector of a loop riser pipe in an open configuration according to one embodiment of the present disclosure;

FIG. 5A is a diagram of a redirector of a loop riser pipe in a closed configuration according to one embodiment of the present disclosure;

FIG. 5B is a diagram of a redirector of a loop riser pipe in an open configuration according to one embodiment of the present disclosure; and

FIG. 6 is a block diagram of a system according to one embodiment of the present disclosure.

### DETAILED DESCRIPTION

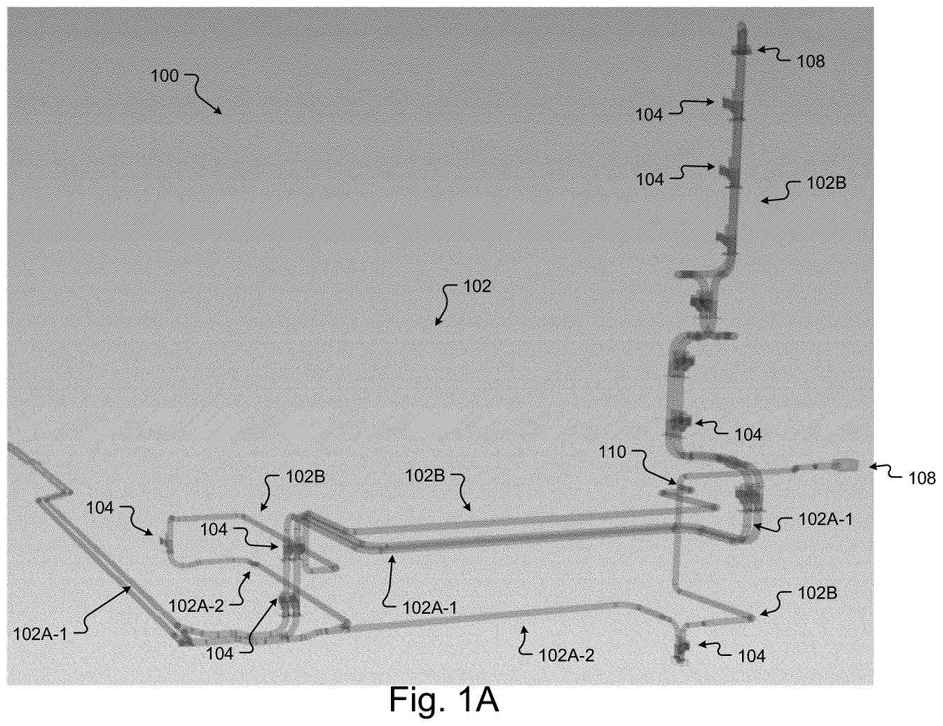

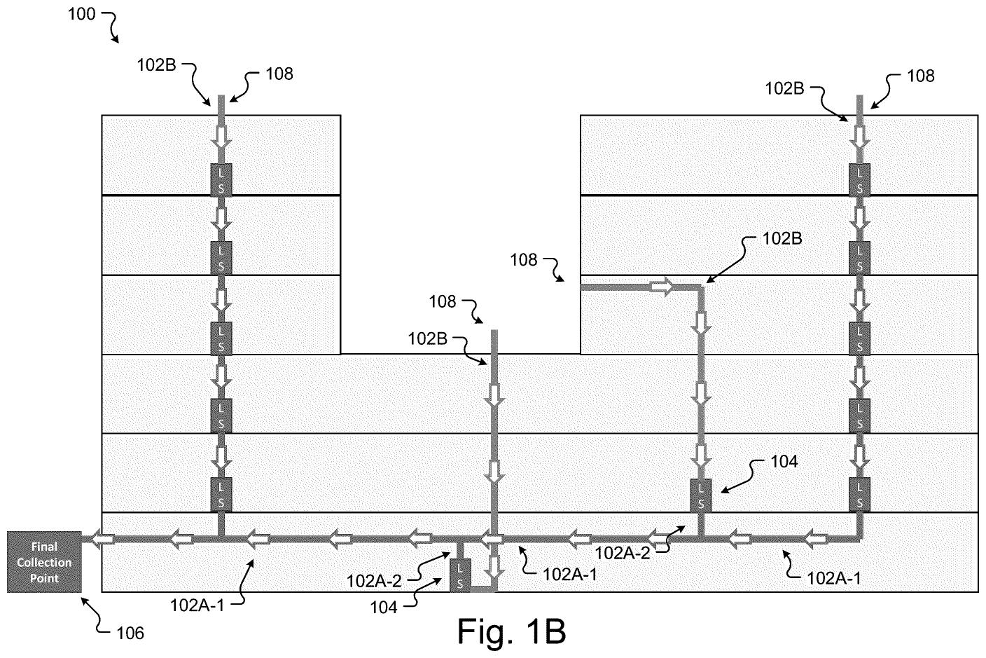

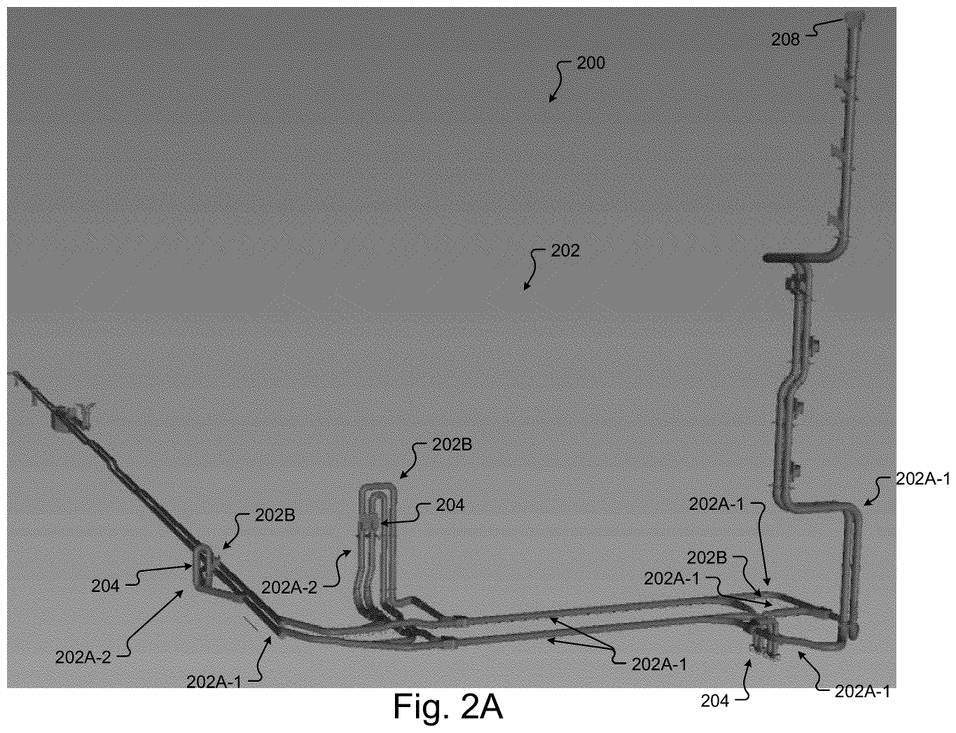

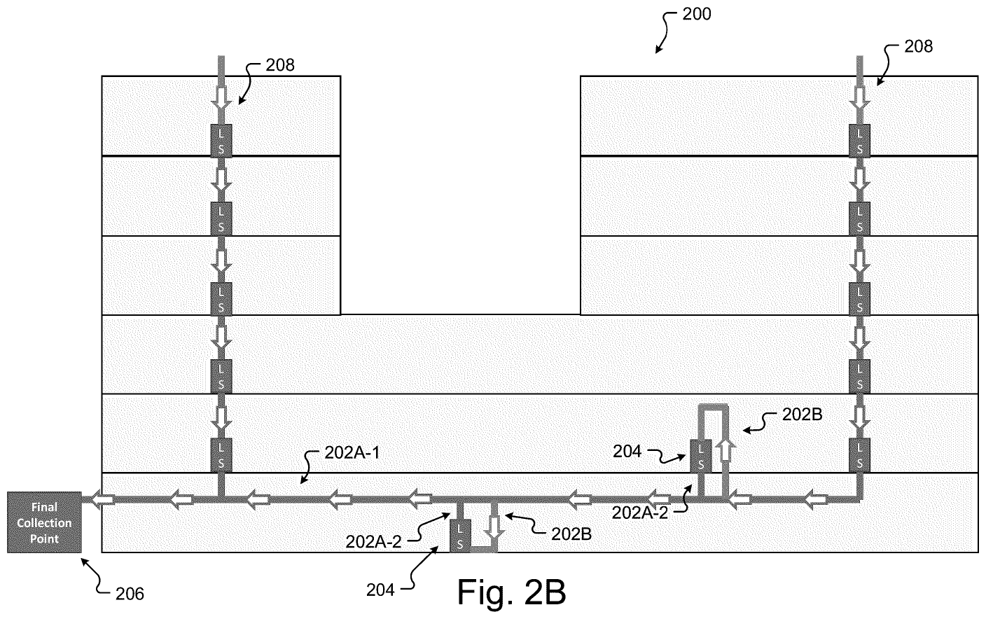

FIGS. 1A and 1B are a perspective view of a transport system 100 and a diagram of the conventional transport system 100, respectively, according to an embodiment of the present disclosure. The transport system 100 comprises a plurality of conduits or tubes 102 operable for transporting objects or materials such as, for example, linen, trash, etc. and/or for delivering air to the conventional transport system 100. More specifically, the set of conduits 102 includes a main transport pipe 102A-1 for transporting objects or materials to a collection area 106, 206 (shown in FIG. 1B or 2B, respectively), one or more branch transport pipes 102A-2 for transporting the objects or materials from one or more loading stations 104 to the main transport pipe 102A-1, and one or more pneumatic pipes 102B for delivering airflow from one or more air or pneumatic sources 108 to each loading station 104. In such systems, it will be appreciated that the main transport pipe 102A-1 and the one or more branch transport pipes 102A-2 are supplied with an airflow from one of the one or more air or pneumatic sources 108 and the one or more pneumatic pipes 102B supply airflow to each loading station 104 to aid in transporting objects or materials deposited at each loading station 104 through a corresponding branch transport pipe 102A-2 and into the main transport pipe 102A-1. In some embodiments, the system may include a pneumatic source 108 for each branch transport pipe 102A-2. In other embodiments, the system may include a pneumatic source 108 for two or more branch transport pipes 102A-2.

In the depicted system 100, each pneumatic pipe 102B extends from a split point 110 near the pneumatic source 108, though it will be appreciated that the split point 110 may be located anywhere in the conventional transport system 100. The split point 110 is where the pneumatic pipe 102B splits from a single pneumatic pipe 102B to two or more pneumatic pipes 102B. As illustrated, longer lengths of pneumatic pipe 102B are used for loading stations 104 that are further away from the pneumatic source 108 or the split point 110. The pneumatic pipes 102B provide airflow to each loading station 104 so that the airflow can aid in moving objects or materials deposited at corresponding loading stations 104 into the main transport pipe 102A-1 via a corresponding branch transport pipe 102A-2. The main transport pipe 102A-1 connects to the collection area 106 such that all objects or materials deposited at any loading station 104 is collected at the collection area 106. In some embodiments, the conventional transport system 100 may include more than one collection area 106.

In the non-limiting embodiment as shown in FIG. 2B, the one or more loading stations 104 are provided on different levels, for example, on different floors of a building. Each of the one or more loading stations has a first end and a second end. The one or more loading stations 104 are directly or indirectly connected to the main transport pipe 102A-1. For example, some of the one or more loading stations located at a higher or lower level have one end directly connected to the main transport pipe 102A-1 and another end connected to a pneumatic pipe 102B. Some middle-level loading stations have two ends both connected to the main transport pipe 102A-1 directly. In the non-limiting embodiment, the airflow is introduced to the transport system 100 from the roof and/or top of the facility. The loading stations 104 are connected to the final collection point 106 through the main transport pipe 102A-1.

FIGS. 2A and 2B are a perspective view of a set of pipes 202 for a transport system 200 and a diagram of the transport system 200, respectively, according to an embodiment of the present disclosure. The transport system 200 is similar to the transport system 100 above, and the transport system 200 includes one or more loop riser pipes 202B. Generally, the transport system 200 comprises the set of pipes 202 which includes a plurality of the pipes or tubes for transporting objects or materials such as, for example, linen, trash, etc. and/or for delivering air to the transport system 200. More specifically, the set of pipes 202 includes a main transport pipe 202A-1 for transporting objects or materials to a collection area 206, one or more branch transport pipes 202A-2 for transporting the objects or materials from one or more loading stations 204 to the main transport pipe 202A-1, and one or more loop riser pipes 202B to form a loop riser that diverts airflow from the main transport pipe 202A-1 to a corresponding loading station 204. In such systems, it will be appreciated that the main transport pipe 202A-1 and the one or more branch transport pipes 202A-2 are supplied with an airflow from one of the one or more air or pneumatic sources 208. In some embodiments, the transport system 200 may include more than one main transport pipe 202A-1. As previously described, the main transport pipe 202A-1 connects to the collection area 206 such that all objects or materials deposited at any loading station 204 are collected at the collection area 206. In other embodiments, the transport system 200 may include more than one collection area 206.

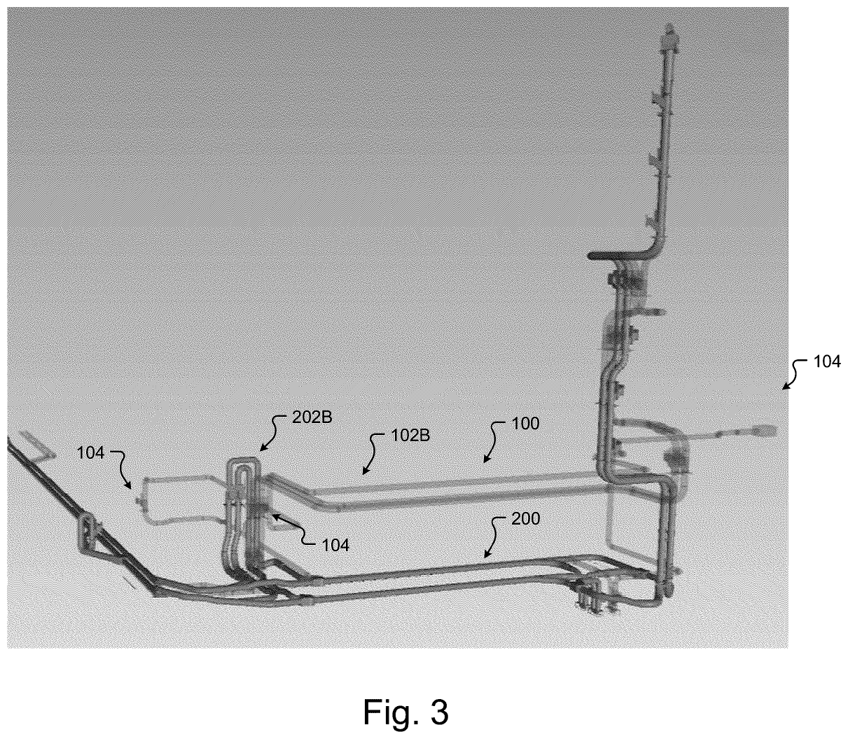

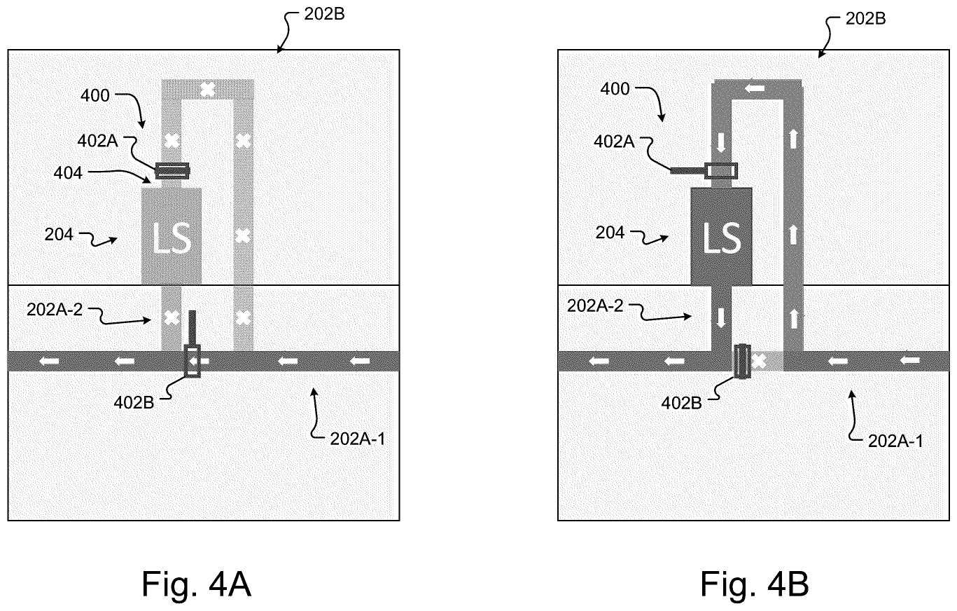

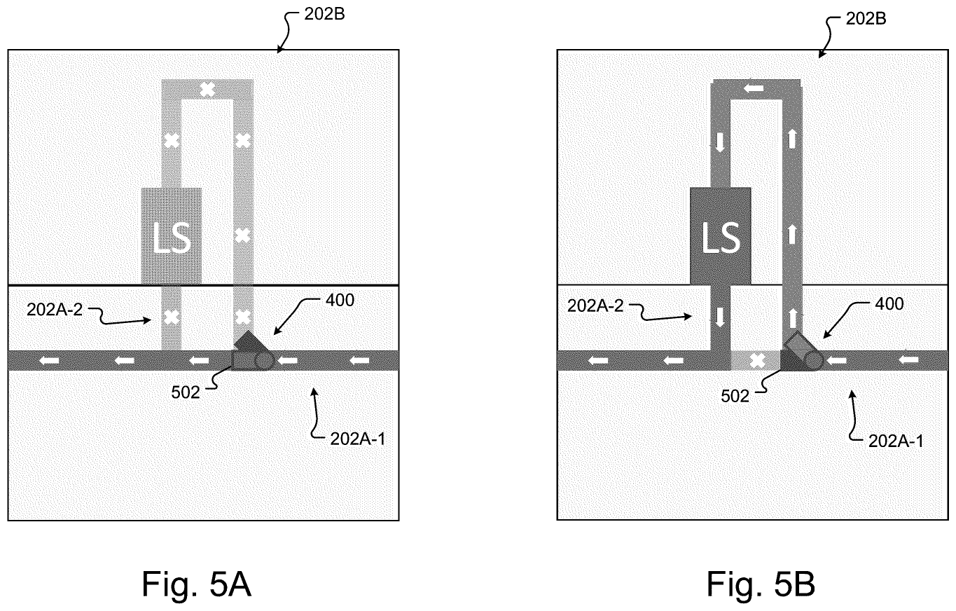

The loop riser pipe(s) 202B as illustrated selectively diverts airflow from the main transport pipe 202A-1 to the corresponding loading station 204 so as to provide airflow at the loading station 204 to aid in moving objects or material deposited at the loading station 204 to the main transport pipe 202A-1, while reducing an overall amount of piping and external connections required in the system (at least compared to the embodiment of FIG. 1B). It will be appreciated that in some embodiments the loop riser pipe 202B may include one or more loading stations 204. In other words, one or more loading stations 204 may be positioned on a loop riser pipe 202B. The loop riser pipe 202B provides airflow to the loading station 204 by selectively redirecting airflow to the loop riser pipe 202B from the main transport pipe 202A-1 using a redirector 400 (shown in FIGS. 4A-5B), as will be discussed in more detail below. The loop riser pipe 202B achieves the same functionality as the pneumatic pipe 102B with less piping, as shown in FIG. 3. In other words, the loop riser pipe 202B achieves the same functionality as the pneumatic pipe 102B with less quantity of piping. More specifically, the pneumatic pipe 102B requires a dedicated pipe from a pneumatic source 108 to a corresponding loading station 104, whereas the loop riser pipe 202B simply connects from the main transport pipe 202A-1 to the corresponding loading station 204. Thus, the distance of piping required for the pneumatic pipe 102B is greater than the distance of piping needed for the loop riser pipe 202B. Similarly, the system 200 also uses less air inlets or pneumatic sources 208, 108 than a conventional system such as the system 100. For example, the system 200 uses two pneumatic sources 208 (shown in FIG. 2B) whereas the system 100 uses four pneumatic sources 108 (shown in FIG. 1B). It will be appreciated that the transport system 200 can include one loop riser pipe, two loop riser pipes, or more than two loop riser pipes.

Turning to FIG. 3, a perspective view of the conventional transport system 100 and the transport system 200 is shown. The conventional transport system 100 is shown transparently to highlight the sections of the pneumatic pipe 102B that are eliminated by the use of the loop riser pipe 202B. A meaningful percentage of the pneumatic pipe 102B (e.g., in some embodiments at least 50%, though in other embodiments, a percentage less than 50% of the pneumatic pipe 102B) is eliminated or removed when replaced with the loop riser pipe(s) 202B, thus beneficially reducing material and cost of the transport system 100, 200. Further, the loop riser pipes 202B are typically used with loading stations 204 that are above or below the main transport pipe 202A-1, which may use pipes with bends or curves to reach the loading stations 204. Because the loop riser pipes 202B divert airflow to a corresponding loading station 204 as needed, this enables the main transport pipe 202A-1 to have fewer bends or turns and remain as straight as possible to efficiently transport objects or materials to the collection area 206. This may result in a reduction in the length of pipe used by, for example, a hundred or more feet. Thus, less material is used, which may result in lower costs in materials, shipping, and installation. Additional cost savings may result from less pipe to maintain and less energy to run the system 200 as air is circulated in shorter distances than conventional systems 100. Further, the reduction in the length of pipe used may result in less space used by the system 200. Additionally, embodiments of the present disclosure reduce the need for external connections through a roof of a building, for example, and related hardware.

Turning to FIGS. 4A-4B, a diagram of a loop riser pipe 202B and an example redirector 400 are shown with one redirector 400 in a closed position and the other redirector 400 in an open position, respectively. The arrows shown in the loop riser pipe 202B and the main transport line 202A-1 are shown for illustrative purposes and represent airflow and a direction of the airflow whereas the “X”s shown represent no airflow. In the illustrated embodiment, the redirector 400 includes a first valve or damper 402A and a second valve or damper 402B. The first damper 402A is positioned on the loop riser pipe 202B upstream of the loading station 204 and the second damper 402B is positioned on the main transport pipe 202A-1 prior to a corresponding branch transport pipe 202A-2. In other words, the first damper 402A can be positioned anywhere on the loop riser pipe 202B between the load station 204 and the main transport pipe 202A-1). The first damper 402A and the second damper 402B are coordinated such that when the first damper 402A is open, the second damper 402B is closed and when the second damper 402B is open, the first damper 402A is closed. Such coordination allows the airflow to either bypass the loop riser pipe 202B and pass through the main transport pipe 202A-1 or to be diverted from the main transport pipe 202A-1 and into the loop riser pipe 202B. When the airflow bypasses the loop riser pipe 202B, the first damper 402A is closed and the second damper 402B is open and when the airflow is diverted to the loop riser pipe 202B, the first damper 402A is open and the second damper 402B is closed. As previously described, when the airflow is diverted into the loop riser pipe 202B, the airflow aids in transporting material or objects deposited at the loading station 204 to the main transport pipe 202A-1 via the branch transport pipe 202A-2 as shown in FIG. 4B. When the airflow bypasses the loop riser pipe 202B, the airflow only travels through the main transport pipe 202A-1, as shown in FIG. 4A.

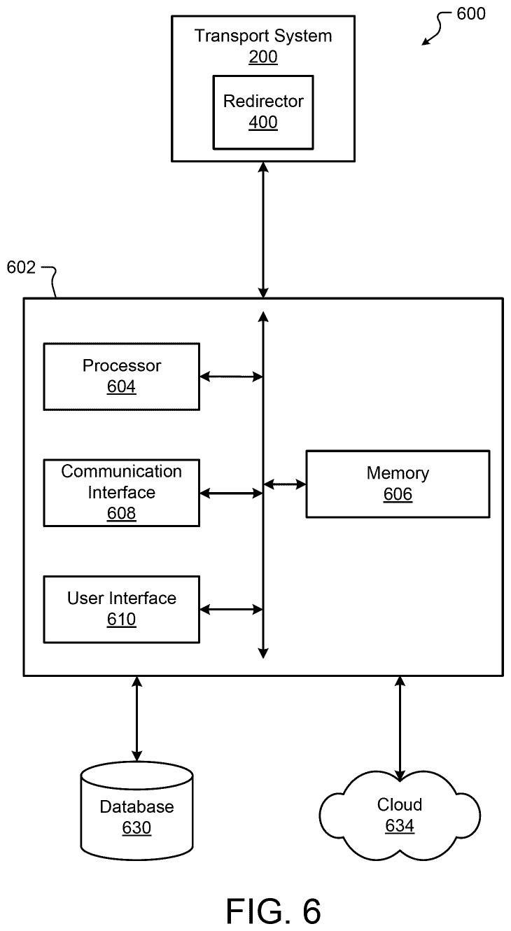

The dampers 402A, 402B may be any type of damper including, for example, mechanical dampers, hydraulic dampers, and/or electromechanical dampers configured to regulate airflow. The dampers 402A, 402B—and more generally, any type of diverter(s) 400—can be controlled by, for example, a computing or control system 600 shown and described in FIG. 6. The computing or control system 600 can automatically open or close the dampers 402A, 402B whether based on input from, for example, a user, or based on automatically sensing that an object or material has been deposited in the loading station 204.

Turning to FIGS. 5A-5B, a diagram of a loop riser pipe 202B in the form a tertiary conduit, and another example of a diverter or redirector 400 are shown with the redirector 400 in a closed position and the redirector 400 in an open position, respectively. The arrows shown in the loop riser pipe 202B and the main transport line 202A-1 are shown for illustrative purposes and represent airflow and a direction of the airflow whereas the “X”s shown represent no airflow. In the illustrated embodiment, the redirector 400 includes a diverter 502. The diverter 502 is positioned at a junction of the loop riser pipe 202B and the main transport pipe 202A-1. When the airflow bypasses the loop riser pipe 202B, the diverter 502 is positioned to prevent airflow to the loop riser pipe 202B and to direct the airflow through the main transport pipe 202A-1. When the airflow is directed to the loop riser pipe 202B, the diverter 502 is positioned so as to prevent airflow to the main transport pipe 202A-1 and to direct the airflow through the loop riser pipe 202B. As previously described, when the airflow is diverted into the loop riser pipe 202B, the airflow aids in transporting material or objects deposited at the loading station 204 to the main transport pipe 202A-1 via the branch transport pipe 202A-2, as shown in FIG. 5B. When the airflow bypasses the loop riser pipe 202B, the airflow only travels through the main transport pipe 202A-1, as shown in FIG. 5A.

The diverter 502 may be any type of diverter including, for example, mechanical diverters such as, for example, a valve, and/or electromechanical diverters configured to regulate airflow. The diverter 502—and more generally, any type of redirector(s) 400—can be controlled by, for example, the computing or control system 600 shown and described in FIG. 6. The computing or control system 600 can automatically open or close the diverter 502 whether based on input from, for example, a user, or based on automatically sensing that an object or material has been deposited in the loading station 204. The control system 600 can further determine and direct an optimal amount of air from the main pipe 202A-1 to bypass the loop riper pipe 202B so that the diverted airflow results in sufficient downward pressure in the loading station 204 to aid the transportation of the material and objects without creating unnecessary or undesired pressure on the objects and materials in the upstream main transport pipe 202A-1 of the loading station 204. It is recognized that a certain amount of airflow velocity through the main transport pipe is desired to create an advantageous pressure differential and draw materials from the loading station 204 to the main transport pipe (i.e. downwardly in FIG. 4B). Accordingly, in preferred embodiments, an optimal amount of air or fluid is drawn by the tertiary conduit or loop riser.

Turning to FIG. 6, a block diagram of a system 600 according to at least one embodiment of the present disclosure is shown. The system 600 may be used to control the redirectors 400 of the transport system 200 or any component of the transport system 200 (e.g., loading stations 204, pneumatic sources 208, etc.). The system 600 comprises a computing or control device 602, a database 630, and/or a cloud or other network 634. Systems according to other embodiments of the present disclosure may comprise more or fewer components than the system 600. For example, the system 600 may not include one or more components of the computing or control device 602, the database 630, and/or the cloud 634.

The computing or control device 602 comprises a processor 604, a memory 606, a communication interface 608, and a user interface 610. Computing or control devices according to other embodiments of the present disclosure may comprise more or fewer components than the computing or control device 602.

The processor 604 of the computing or control device 602 may be any processor described herein or any similar processor. The processor 604 may be configured to execute instructions stored in the memory 606, which instructions may cause the processor 604 to carry out one or more computing steps utilizing or based on data received from the transport system 200. For example, the processor 604 may generate, execute, and/or transmit instructions to the redirector(s) 400 to cause the redirector(s) to automatically open or close.

The memory 606 may be or comprise RAM, DRAM, SDRAM, other solid-state memory, any memory described herein, or any other tangible, non-transitory memory for storing computer-readable data and/or instructions. For instance, the memory 606 may store content (e.g., instructions and/or machine learning models) that, when executed by the processor 604, enable the control of, for example, the redirector(s) 400. Such content, if provided as in instruction, may, in some embodiments, be organized into one or more applications, modules, packages, layers, or engines. Alternatively or additionally, the memory 606 may store other types of content or data (e.g., machine learning models, artificial neural networks, deep neural networks, etc.) that can be processed by the processor 604 to carry out the various method and features described herein. Thus, although various contents of memory 606 may be described as instructions, it should be appreciated that functionality described herein can be achieved through use of instructions, algorithms, and/or machine learning models. The data, algorithms, and/or instructions may cause the processor 604 to manipulate data stored in the memory 606 and/or received from or via the transport system 200.

The computing or control device 602 may also comprise a communication interface 608. The communication interface 608 may be used for receiving information from an external source (such as the transport system 200, the cloud 634, and/or any other system or component not part of the system 600), and/or for transmitting instructions, images, or other information to an external system or device (e.g., another computing or control device 602, the transport system 200, the database 630, the cloud 634, and/or any other system or component not part of the system 600). The communication interface 608 may comprise one or more wired interfaces (e.g., a USB port, an Ethernet port, a Firewire port) and/or one or more wireless transceivers or interfaces (configured, for example, to transmit and/or receive information via one or more wireless communication protocols such as 802.11a/b/g/n, Bluetooth, NFC, ZigBee, and so forth). In some embodiments, the communication interface 608 may be useful for enabling the device 602 to communicate with one or more other processors 604 or computing or control devices 602, whether to reduce the time needed to accomplish a computing-intensive task or for any other reason.

The computing or control device 602 may also comprise one or more user interfaces 610. The user interface 610 may be or comprise a keyboard, mouse, trackball, monitor, television, screen, touchscreen, and/or any other device for receiving information from a user and/or for providing information to a user. The user interface 610 may be used, for example, to receive a user selection or other user input for controlling the transport system 200. Notwithstanding the foregoing, any required input for any step of any method described herein may be generated automatically by the system 600 (e.g., by the processor 604 or another component of the system 600) or received by the system 600 from a source external to the system 600.

Although the user interface 610 is shown as part of the computing or control device 602, in some embodiments, the computing or control device 602 may utilize a user interface 610 that is housed separately from one or more remaining components of the computing or control device 602. In some embodiments, the user interface 610 may be located proximate one or more other components of the computing or control device 602, while in other embodiments, the user interface 610 may be located remotely from one or more other components of the computer device 602.

The database 630 may store information about the transport system 200 such as, for example, operating parameters, airflow parameters and/or thresholds, etc. The database 630 may be configured to provide any such information to the computing or control device 602 or to any other device of the system 600 or external to the system 600, whether directly or via the cloud 634.

The cloud 634 may be or represent the Internet or any other wide area network. The computing or control device 602 may be connected to the cloud 634 via the communication interface 608, using a wired connection, a wireless connection, or both. In some embodiments, the computing or control device 602 may communicate with the database 630 and/or an external device (e.g., a computing device) via the cloud 634.

The system 600 may be used with the system 200 to control one or more aspects of the system 200 such as, for example, when to divert airflow to a loop riser pipe 202B via the redirector(s) 400.

The examples set forth above are provided to give those of ordinary skill in the art a complete disclosure and description of how to make and use the embodiments of the methods for prediction of the selected modifications that may be made to a biomolecule of interest and are not intended to limit the scope of what the inventors regard as the scope of the disclosure. Modifications of the above-described modes for carrying out the disclosure can be used by persons of skill in the art and are intended to be within the scope of the following claims.

It is to be understood that the disclosure is not limited to particular methods or systems, which can, of course, vary. It is also to be understood that the terminology used herein is for the purpose of describing particular embodiments only and is not intended to be limiting.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A materials transport system comprising:
a main transport pipe operable to transport fluid and materials, the main transport pipe comprising an upstream portion and a downstream portion and connected to a collection area;
a loading station in communication with the main transport pipe;
a dedicated fluid conduit operable to convey fluid from the main transport pipe to the loading station, the dedicated fluid conduit comprising a first end in communication with the main transport pipe at a location upstream of the loading station and a second end in communication with the loading station;
at least one of a damper and a valve configured to selectively direct fluid from the main transport pipe to the loading station.

2. The materials transport system of claim 1, wherein the at least one of a damper and a valve is provided at the first end of the dedicated fluid conduit.

3. The materials transport system of claim 1, wherein the system comprises a first damper and a second damper, the first damper provided at an intersection of the main transport pipe and the dedicated fluid conduit, and the second damper provided in at least one of the dedicated fluid conduit and the loading station.

4. The materials transport system of claim 1, wherein the dedicated fluid conduit comprises at least one of a filter and a screen to permit air to flow into the dedicated fluid conduit and prevent solid materials from flowing into the dedicated fluid conduit.

5. The transport system of claim 1, further comprising a controller operable to receive and send information to at least one of the loading station and the at least one of a damper and a valve.

6. A transport system comprising:
a main transport pipe connected to a collection area;
a branch transport pipe extending between the main transport pipe and a loading station;
a dedicated air conduit extending between the main transport pipe and the at least one loading station; and
a redirector system configured to regulate airflow between the dedicated air conduit and the main transport pipe, the redirector comprising a first damper and a second damper.

7. The transport system of claim 6, wherein when the first damper and the second damper are coordinated such that when the first damper is open, the second damper is closed, and wherein when the second damper is open, the first damper is closed.

8. The transport system of claim 6, wherein at least one of the first damper and the second damper are controlled based on a status of the loading station.

9. The transport system of claim 6, wherein the first damper is provided in communication with the main transport pipe and the second damper is provided in communication with the dedicated air conduit.

10. The transport system of claim 6, further comprising a controller in communication with the first damper and the second damper.

11. The transport system of claim 10, wherein the control system is capable of automatically opening or closing the first and second dampers based on a user input.

12. The transport system of claim 10, wherein the control system is capable of automatically opening or closing the first and second dampers based on input from sensing an object being deposited in loading station.

13. The transport system of claim 6, further comprising a control device, wherein the control device comprises
a processor;
a memory;
a communication interface; and
a user interface.

14. A transport system comprising:
a main transport pipe connected to a collection area;
a branch transport pipe connected to the main transport pipe and at least one loading station;
a tertiary conduit extending between the main transport pipe and the at least one loading station; and
a redirector configured to regulate airflow to direct at least one of airflow and material to the tertiary conduit.

15. The transport system of claim 14, wherein the diverter is positioned at a junction of the tertiary conduit and the main transport pipe.

16. The transport system of claim 14, wherein when an airflow bypasses the tertiary conduit, the diverter is positioned to prevent airflow to the tertiary conduit and direct the airflow through the main transport pipe.

17. The transport system of claim 14, wherein when the airflow is directed to the tertiary conduit, the diverter is positioned so as to prevent airflow to the main transport pipe and to direct the airflow through the tertiary conduit.

18. The transport system of claim 14, wherein the diverter is selected from the group consisting of a valve, an electromechanical diverter, and a mechanical diverter.

19. The transport system of claim 14, wherein the redirector can be controlled by a control system, wherein control system is capable of opening and closing the diverter based on input from a user or automatically sensing that an object or material being deposited into the loading station.

20. The transport system of claim 14, further comprising a control device, wherein the control device comprises
a processor;
a memory;
a communication interface; and
a user interface.
